(19) United States
(12) Patent Application Publication
(10) Pub. No.: US 2015/0097667 A1
(43) Pub. Date: Apr. 9, 2015

(54) SYSTEMS AND METHODS FOR ALERTING ON-SITE RESPONDERS LOCATED AT A SPECIFIC FACILITY TO ENGAGE AND NEUTRALIZE A THREAT

(71) Applicant: Cathryn Cruse, Ridge Spring, SC (US)

(72) Inventor: Cathryn Cruse, Ridge Spring, SC (US)

(21) Appl. No.: 14/046,061

(22) Filed: Oct. 4, 2013

(51) Int. Cl. G08B 21/02; G08B 25/10

(52) U.S. Cl. CPC G08B 21/02; G08B 25/10
USPC 340/539.11

(57) ABSTRACT

In an embodiment of the disclosed technology, an emergency response system is used on the premises of a given location or building. The system employs various staff members who are regularly present throughout the facility at random locations. These individuals are each wearing a personal transmitter which, when activated, transmits a distress signal through wireless systems. The distress signal includes the location of the personal transmitter at the time of transmission. Once the transmitted location is received at a central server, the information is then processed and assigned a room number or identifier that is then delivered by a wireless communications system to an on-site, first responding marshal within the facility.

### FIELD OF THE DISCLOSED TECHNOLOGY

The disclosed technology relates generally to emergency response systems and, more specifically, to an on-site system for neutralizing a potentially dangerous threat.

### BACKGROUND OF THE DISCLOSED TECHNOLOGY

In recent events involving an active shooter at a public place such as a school, theater complex, college campus or similar, a number of people were fatally wounded or injured in a very short period of time. In many cases, by the time local law enforcement agencies manage to respond to the scene, it may already be too late.

Current methods of surveillance include video cameras that are located at strategic points in a facility. The live feeds from these cameras are displayed in a central location, where they are monitored. Once a situation is captured on video, if it is actually observed, then a witness alerts 911 which possibly dispatches a security officer to the scene. In this scenario, it is necessary to rely on the vigilance of one person who is responsible for monitoring an entire facility. Video systems are expensive and difficult to maintain. A second method of surveillance is the roaming security guard or marshal. In this instance, the close proximity of a guard to the scene of an emergency while that emergency is unfolding is not guaranteed. Radios and pagers contribute some efficiency, but there is currently no method for instant, reliable emergency services within a facility.

In reaction to recent events, several states have already passed legislation allowing teachers or other faculty members to carry weapons into schools or other facilities. This random and indiscriminate arming of individuals can lead to more violence when, or if they are not capable of controlling their weapon, and/or if the person is not properly vetted or investigated. Texas has implemented a school marshal program, but it does not include the means to bring that marshal to the point where he/she is needed instantly.

### SUMMARY OF THE DISCLOSED TECHNOLOGY

Therefore, it is an object of the disclosed technology to provide a system incorporating wireless-messaging and position-tracking technologies, together with professionally trained and armed marshals who are located within a given facility.

As such, in an embodiment of the disclosed technology, a method provides a plurality of transmitters and transceivers to employees and marshals, respectively, present at defined premises. Next, a signal is received from an activated transmitter of the plurality of transmitters. The method proceeds by determining a named location within the premises corresponding to the activated transmitter. Next, a notification is sent to the transceiver located on the premises. The notification contains data regarding the activated transmitter, such as, for example, the named location of the activated transmitter and the transceiver's proximity thereto. Simultaneously, a notification is sent to at least one emergency responder at a location other than the premises. The emergency responder may be, for example, a local police department, fire department, or emergency medical service.

In further embodiments of the disclosed method, the data may also contain information regarding the proximity of the transceiver to the activated transmitter compared to proximities of other transceivers. For example, the notification may inform a marshal that he or she is the second closest to the activated transmitter, and that no other marshals are within a certain range. Such information may be pertinent to the marshal's approach when responding to the emergency situation. The data may further include a room or area identifier, such as, for example, “the tennis courts,” “room number 24” or “second floor hallway.”

“Employees,” for purposes of this disclosure, are defined as any individual who may be regularly or occasionally present at specific premises. The individual need not necessarily be employed by, or on the payroll of, the owner or company present on the premises. That is, the individual may be a student at a school or a regular visitor of a park. However, the individual is considered an “employee” to the extent that he or she has taken on the task of carrying or activating a transmitter within the confines of the premises.

“Marshals,” for purposes of this disclosure, are defined as any designated individual who is armed and/or trained to respond to an emergency situation, such as, for example, a violent threat involving a person carrying a weapon. “Marshals” may be security personnel or police assigned to patrol and protect given premises. “Marshals” may also be regular employees or volunteers present at a given location primarily for purposes other than security. For example, a teacher at a school may take on the role of a “marshal,” if he/she is qualified to do so. Qualifications may include, for example, permission to carry a concealed weapon and/or training in neutralization of a violent threat. Generally, each marshal carries a transceiver and is notified of a perceived emergency via an activated transmitter. Conceivably, a marshal may also be an “employee” and may also carry a transmitter for reporting an incident, for purposes of this disclosure.

The location of the activated transmitter may be determined using a global positioning system (GPS) tracker associated with the transmitter. Alternatively, the transmitter may have a GPS receiver, whereby acquired GPS coordinates are transmitted via the signal upon activation of the transmitter. In another embodiment, the location of the activated transmitter may be determined by triangulation of the transmitted signal.

In another embodiment of the disclosed technology, a method facilitates emergency response on given premises. The method proceeds, not necessarily in the foregoing order, by: a) equipping an armed marshal at the premises with an emergency transceiver; b) receiving a signal transmitted from an activated transmitter on the premises; c) determining an actual location of the transmitted signal on a pre-configured plan of the premises; d) translating the actual location into a named area of the premises; e) sending a notification to the transceiver carried by the armed marshal, the notification comprising the named area corresponding to the activated transmitter location; and f) communicating the named area and an address of the premises to at least one emergency responder.

In further embodiments of this method, the notification may also inform the armed marshal of his or her distance to the activated transmitter location. Still further, the notification may have information regarding the proximities/distances of other armed marshals with respect to the armed marshal and his or her distance to the activated transmitter location.

In a still further embodiment of this method, the notification may also involve displaying the plan on the transceiver carried by the marshal. “Plan,” for purposes of this disclosure, is defined as any map, floor plan, schematic and/or diagram which provides a scaled visual representation of given premises. Typically, a “plan” is a two-dimensional representation of the premises, having labels and showing locations of major physical features such as walls, stairs, roads, sidewalks, structures, etc. The plan may be shown on a display of the transceiver. If the transceiver is a smart phone or tablet, the plan may be incorporated into a pre-existing mapping application on the device, or it may be pre-downloaded and/or pre-cached to the device for quick access.

The location of the activated transmitter may be visually represented in the context of the plan. For example, if the activated transmitter is determined to be in the “gymnasium,” then it will be indicated as such on the plan by showing a flashing dot or similar indicator. Locations of the marshal (vis-a-vis the transceiver) and/or other nearby marshals may also be displayed on the plan. If applicable and/or necessary, the transceiver may display directions to follow so as to reach the activated transmitter, or turn-by-turn navigation if the method is employed on large-scale premises, such as a college campus.

In a further embodiment of the disclosed method, another step is provided of notifying additional marshals about the activated transmitter. In this embodiment, at least a second marshal is notified regarding the activated transmitter. The second marshal is also informed of the fact that a closer marshal has also been notified. This step may include notifying multiple marshals, or all marshals present on the premises or within a given area thereof. Thus, for example, third, fourth and fifth marshals may also be notified and informed that they are third, fourth and fifth, respectively, in order of distance and predicted arrival to the occurring incident. As such, the second marshal and any subsequent marshals may be informed to proceed appropriately to the incident on the basis that they will likely be providing backup assistance to a first responding marshal already at the scene.

In a still further embodiment, the signal from the activated transmitter is received by the transceiver, and a distance to the activated transmitter is determined by assessing the strength of the signal. The transceiver may use the direction and strength of the signal to navigate to, and/or locate, the activated transmitter.

In still another embodiment of the disclosed technology, a system is used for responding to an emergency on given premises. The system's components generally include a plurality of transmitters, a plurality of transceivers (which may both transmit and receive), and a server. The transmitters, upon activation, transmit signals. Each transmitter is carried by, and/or associated with, an employee present on the premises. Each of the transceivers has a display and wireless connectivity.

“Wireless connectivity,” for purposes of this disclosure, is defined as any connection over a local area network, wide area network, cellular network, packet switch data network, radio network and/or any other network by which signals and/or information may be wirelessly transmitted. Each of the transceivers is associated with, and carried by, a marshal who is present on the premises. “Present” on the premises, for purposes of this disclosure, is defined as being regularly present on the premises, during operational hours, for an extended amount of time. Furthermore, a marshal who is consistently on the premises at a specific day of the week and time, such as, for example, 9 AM to 5 PM on Tuesdays and Thursdays, would be considered “present” on the premises.

The server may be at a remote location and may not necessarily be on or near the premises. The server has a processor for carrying out commands and memory for storing information, such as the layout/plan of the premises. The server receives and identifies the origin of signals transmitted from the transmitters. The server then transmits information regarding the origin of the signal to the transceivers, so that the marshals may act accordingly.

It should be understood that the use of “and/or” is defined inclusively such that the term “a and/or b” should be read to include the sets: “a and b,” “a or b,” “a,” “b.”

### BRIEF DESCRIPTION OF THE DRAWINGS

FIG. 1 is a flow diagram outlining steps of a method of an embodiment of the disclosed technology.

FIG. 2 is a high level drawing of the interaction between transmitters and alerting devices, according to an embodiment of the disclosed technology.

FIG. 3 is a high level drawing of an exemplary system, according an embodiment of the disclosed technology.

FIG. 4 is a high level block diagram of a node that may be used to carry out an embodiment of the disclosed technology.

### DETAILED DESCRIPTION OF EMBODIMENTS OF THE DISCLOSED TECHNOLOGY

In an embodiment of the disclosed technology, an emergency response system is used on the premises at a given facility. The system employs various staff members or others who are regularly present throughout the facility at random locations. These individuals are each wearing a personal transmitter which, when activated, transmits a distress signal through wireless systems. The distress signal includes the location of the personal transmitter at the time of transmission. These individuals preferably have the most intimate knowledge of their facility and are the most conscientious in securing it. Once the transmitted location is received at a central server, the information is processed and assigned a room number that is then delivered by a wireless communications system to an on-site, first responding marshal within the facility. Thus, response time may drastically be reduced from minutes to seconds, thereby saving lives. The system may also reduce the dependence of a facility on video surveillance, entry control measures and costs associated with adding more security guards or marshals.

The system and methods may be employed at a large-scale facility. “Premises,” for purposes of this disclosure, may be any large area, facility or structure that encompasses many independent halls, zones, sections, lawns, shops, classrooms, offices, stores, apartments, rooms, manufacturing areas, production lines, storage, or other designated separate areas where large numbers of people may gather. Premises can also be an outdoor venue such as a sports arena, park, parking garage, stadium, facilities for athletic events, recreational events, or any other outdoor event designed for large groups of people gathering for extended periods of time. Some examples of premises may include a high school, a college campus, a public park, or a shopping mall.

Accordingly, this system is comprised of two types of personal devices: an alert device for the on-site marshal, and a personal transmitter for the person who is at the scene of the incident. The personal transmitter is a small, discrete position-tracking device that may be battery-powered, rechargeable, and easy to attach to a collar, belt or pocket. The device utilizes standard position tracking technology to ensure transmission of precise location information. Wireless technology is employed for relaying the location back to the server. Each device has a universal serial bus (herein “USB”) connection for charging the battery, a blinking LED for power indication. and/or a button, that, when depressed firmly, activates the transmission of its location to the server and, in turn, on to an on-site marshal. The alerting device carried by the on-site marshal may be a small, discrete messaging device that can be attached to a belt or pocket. The device may have a USB charging connection, a blinking LED for power indication and/or a small display that reads out the location of the emergency incident.

The central server is programmed to receive position information and to correlate the information to room numbers or areas for a given facility. The server is configured to identify room numbers, classrooms, hallways, parking areas, etc. When a personal transmitter device is activated, the transmitted and received position data will be compared to previously programmed facility dimensions, indicating where the device is with respect to these programmed parameters. For example, a facility housing a gymnasium may have the dimensions for the gymnasium pre-programmed into the server. When a transmitter is activated inside the gymnasium, it will transmit a set of coordinates that fall within the pre-programmed border of the gymnasium. Thus, the server will correlate the location to be within the confines of the “gymnasium.” As such, the text transmitted to the on-site marshal will indicate that an incident is taking place in the gymnasium. Simultaneously, the server will be programmed to notify local emergency responders (i.e., 911) through a direct link, such as a telephone line or other method.

The system may also employ a maintenance terminal and USB charging multi-port for alerting devices. The maintenance terminal may be used for monitoring the health, status and/or battery life of the personal transmitters and/or alerting devices. Moreover, the maintenance terminal may be used for making adjustments to programming coordinates, dimensions or layouts of a given facility.

Embodiments of the disclosed technology will become clearer in view of the following description of the drawings.

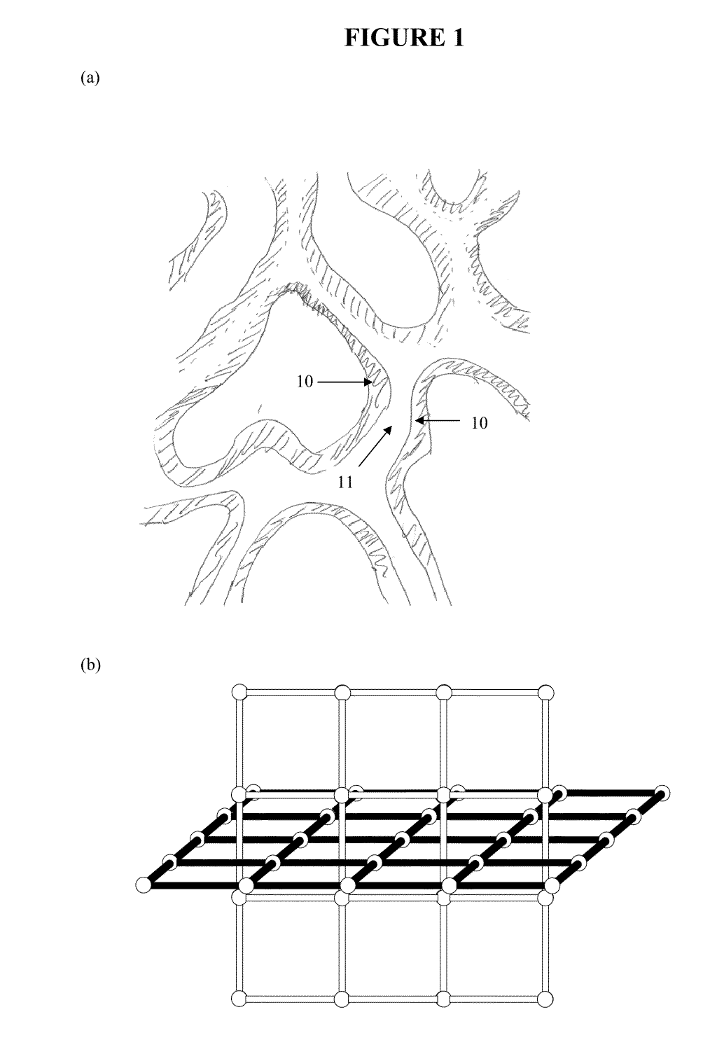

FIG. 1 is a flow diagram outlining steps of a method of an embodiment of the disclosed technology. More specifically, the following steps outline the process for reporting and responding to an emergency. An “emergency” is defined as any incident requiring immediate medical, fire department, and/or law enforcement response. In embodiments of the disclosed technology, the emergency may involve a violent threat, such as an unsolicited individual carrying a firearm or other weapon.

In step 100, the method begins, whereby an employee carrying a transmitter may be witnessing or perceiving a violent threat or other emergency. In step 110, the employee presses a button on the transmitter that he or she is carrying in order to activate the transmitter. In step 120, the pressing of the button causes the actuation of a signal from the transmitter. Then, in step 130, information is transmitted wirelessly via the signal towards a server. The signal may be transmitted via any type of wireless network, such as, for example, a local area network (LAN), a wide area network (WAN), a mobile phone network, a packet-switch data network, radio waves, or any other means for wirelessly sending information.

Referring still to FIG. 1, the method continues in step 140, whereby the transmitted information is received by the server. Upon receipt of the signal, in step 150, the server makes a determination of the position from which the signal is being transmitted. Determination of the transmission locale may be carried out via global positioning system (GPS) or triangulation of the signal. If the determination is carried out using GPS, then the transmitter may be equipped with a GPS receiver. The GPS receiver is capable of determining location coordinates of the transmitter. The coordinates are transmitted to the server along with the signal and any other relevant information.

The method proceeds with step 160 in which a notification is sent from the server. The notification includes information about the emergency, such as, for example, the location of the emergency and the nature of the emergency. The notification may be triggered by the press of an emergency button on a wall or otherwise fixedly attached the premises and/or by way of an emergency transmitter carried by an employee at the premises, including a marshal. The notification is sent in step 170 to an on-site marshal or responder (herein “marshal” or “on-site marshal”). If multiple on-site marshals are present in a given perimeter or building, then the notification may be sent to each of the marshals. Alternatively, the notification may be sent to only those marshals who are, at the time of the emergency, closest to the location of the emergency. The determination of location of the marshals may be carried out via GPS or triangulation with regard to an emergency alerting device carried by each of the marshals. The notification may be, for example, a text message sent to a mobile device of the on-site marshal. Alternatively, the on-site marshal may carry an emergency alerting device, similar to a pager, which serves to communicate emergency information to the marshal.

If multiple on-site marshals are present in a given facility, the one closest to the incident may receive a notification indicating such. Furthermore, other nearby marshals may, in addition to receiving the notification, be notified that they are within a specified radius of the incident and should make it a priority to respond. Additionally, multiple marshals may each be assigned a number or rank based on their proximity to the incident; the closest being assigned the number 1, the second closest being assigned the number 2, and so forth.

Additionally, in step 175, a notification is sent to a local emergency responder, such as a police department. The notification may be in the form of a call to 911. During the call, the location information may be communicated to the local emergency responders.

In step 180 the on-site marshal travels to the location of the emergency using the information received in the notification. If the system is carried out in a building, the location information may include the floor and room number in which the incident is presently occurring. Furthermore, the alerting device or mobile device of the marshal may display a floor plan or map indicating the location of the incident. Still further, the marshal may be presented with directions or navigation instructions for reaching the site of the incident.

In step 185, the local emergency responders travel to the location of the emergency. Since the on-site marshal is the closest to the incident, the on-site marshal would reach the location before the local emergency responders. Thus, the local emergency responders would assist in back up of the on-site marshal, and carrying out any criminal investigation and/or arrest procedures that may be required as governed by local laws. In step 190, the threat is neutralized. The marshal is preferably trained and equipped to properly carry out the neutralization of a threat. As such, the marshal may be permitted, as dictated by local laws, to carry a firearm.

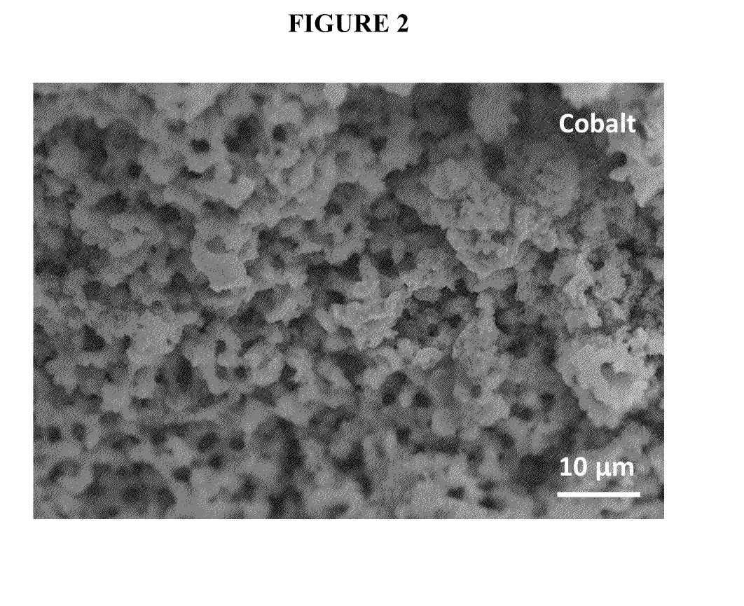

FIG. 2 is a high level drawing of the interaction between transmitters and alerting devices, according to an embodiment of the disclosed technology. The system generally employs a server 200, one or more network nodes 210 & 220, at least one emergency alert device 215, and a plurality of personal transmitters 225. The emergency alert device 215 is associated with, and carried by, an on-site marshal 230. Each personal transmitter of the plurality of personal transmitters is associated with an employee who is regularly present at the premises where the emergency response system is utilized. Thus, if the system is employed in a school, each teacher may be given a personal transmitter, or a transmitter may be placed in each classroom.

The nodes 210 & 220 serve to facilitate communication between alert device 215 and transmitters 225, and server 200. More specifically, node 210 facilitates communication between the emergency alert device 215 and the server 200. Node 220 facilitates communication between each personal transmitter 225 and the server 200. The personal transmitter 225 may only be capable of sending signals via the node 220, as indicated by the one-way directional arrows in FIG. 2. The server 200 may be located anywhere, and is not necessarily located at the premises in which the system is employed. The server 200 may additionally communicate directly with a local emergency responder, such as, for example, 9-1-1 230. Communication to the local emergency responder may be carried out via a dedicated land line.

The signal from the activated transmitter may also be received directly by the transceiver 215. The transceiver 215 may then determine the location of the activated transmitter by assessing the direction and the strength of the signal. The transceiver 215 may then use the direction and strength of the signal to navigate to and/or locate the activated transmitter. Such would be beneficial in a facility where wireless connectivity via cellular network or local area network may be spotty.

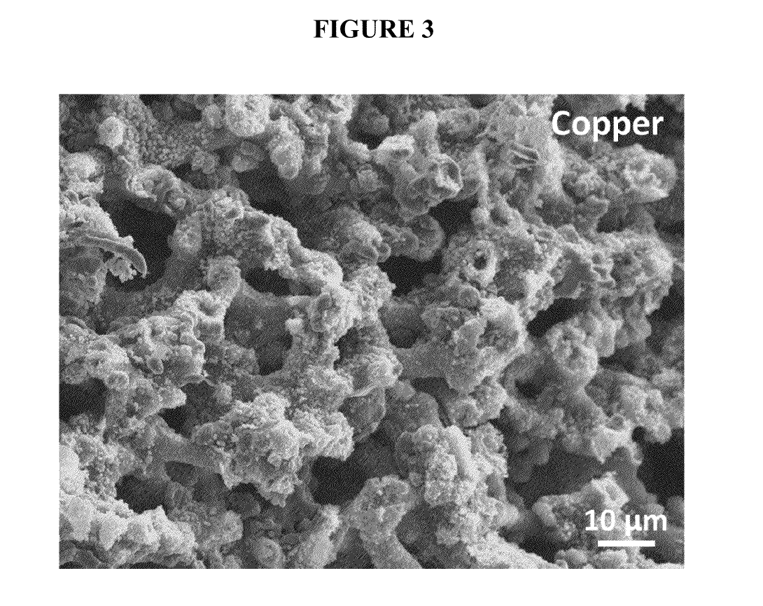

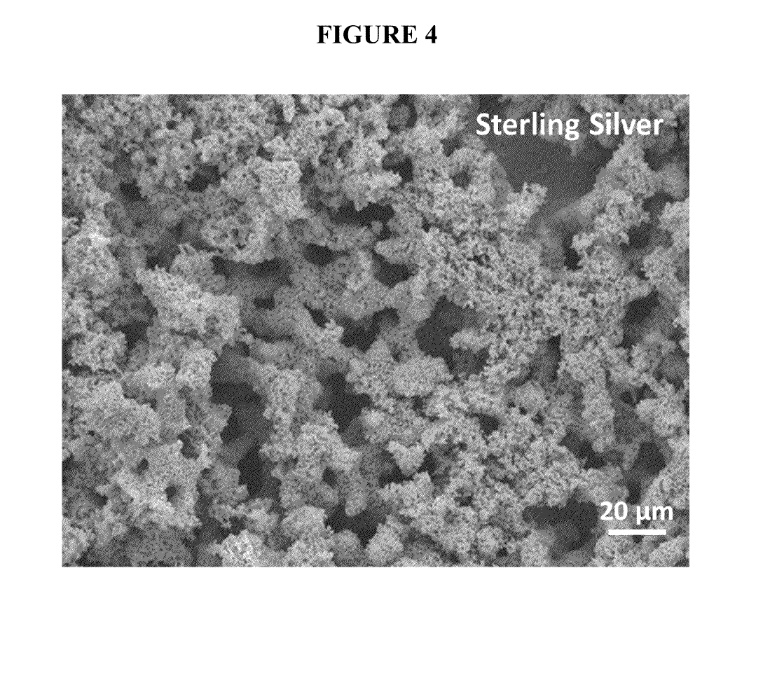

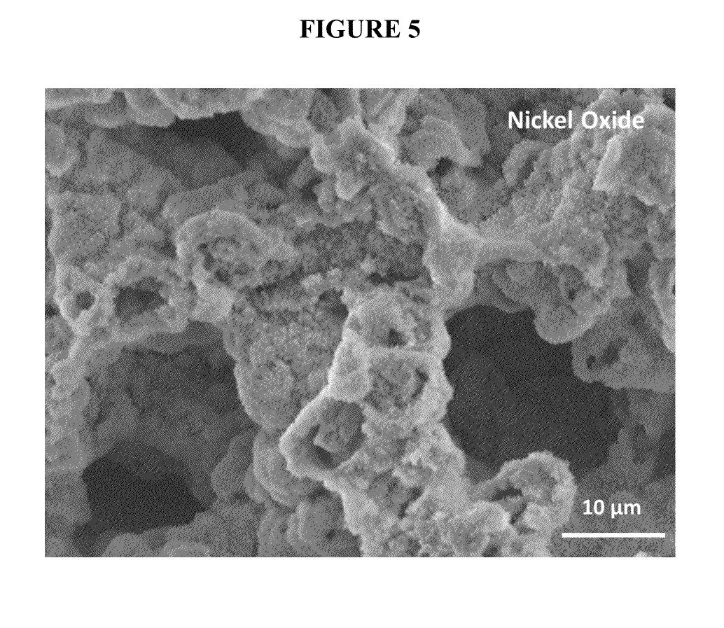

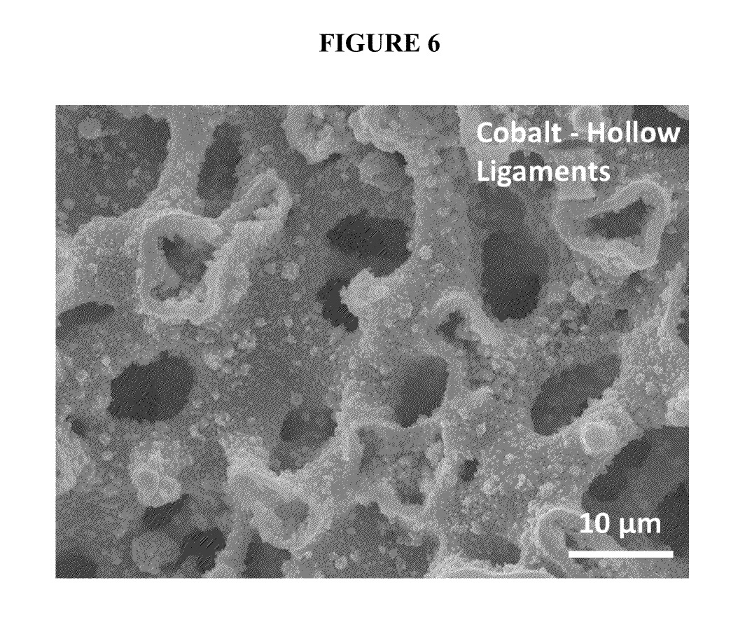

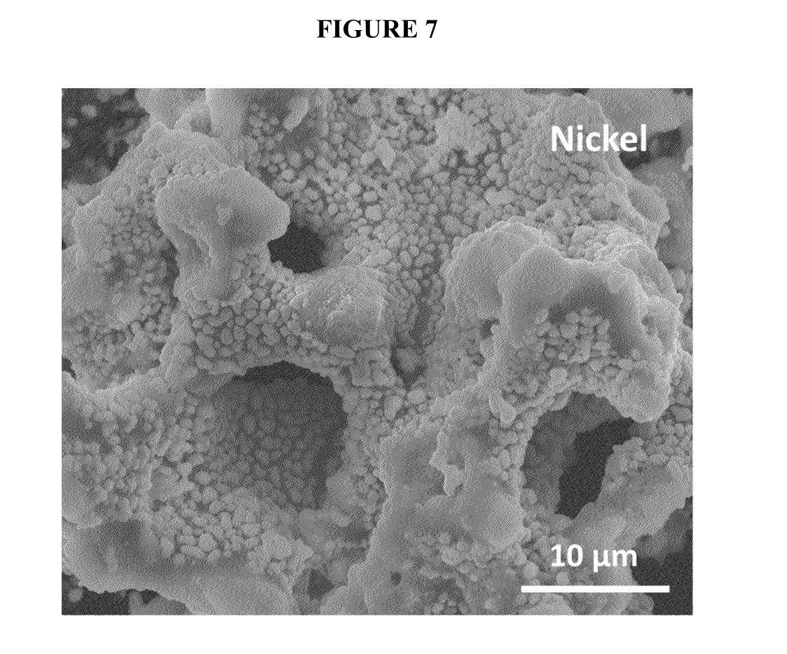

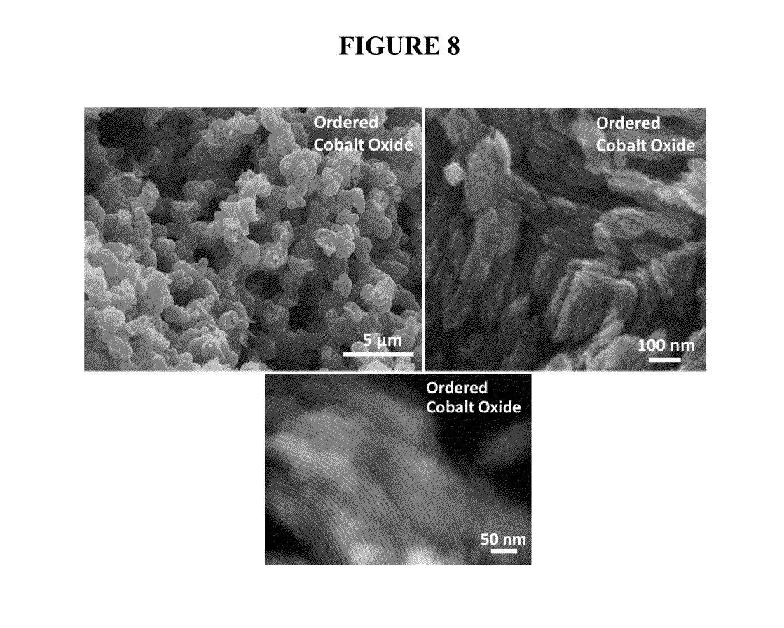

FIG. 3 is a high level drawing of an exemplary system, according to an embodiment of the disclosed technology. FIG. 3 gives a general overview of how a system may be arranged when employed at a particular location. Generally, a plurality of personal transmitters 300, 310, 320 is configured to be in communication with a node 330. When information is transmitted via a signal to the node 330, the information is analyzed, correlated and/or decoded by the server 340. In an embodiment thereof, a server 340 comprises a processor 341, memory 342, input/output 343, storage 344, and a network interface 345. These features correspond to those described in further detail below with regard to FIG. 4 and the description thereof, below.

FIG. 4 is a high level block diagram of a node that may be used to carry out an embodiment of the disclosed technology. Node 400 comprises a processor 450 that controls the overall operation of the computer by executing the transceiver's program instructions which define such operation. The nodes' program instructions may be stored in a storage device 420 (e.g., magnetic disk, database) and loaded into memory 430 when execution of the console's program instructions is desired. Thus, the nodes' operation will be defined by the transceiver's program instructions stored in memory 430 and/or storage 420, and the console will be controlled by processor 450 executing the console's program instructions. A node 400 also includes one or a plurality of input network interfaces for communicating with other devices via a network (e.g., the Internet). A node 400 also includes one or more output network interfaces 410 for communicating with other devices. Bi-directional transceiver 400 also includes input/output 440 representing devices which allow for user interaction with a computer (e.g., display, keyboard, mouse, speakers, buttons, etc.). One skilled in the art will recognize that an implementation of an actual device will contain other components as well, and that FIG. 4 is a high level representation of some of the components of such a device for illustrative purposes. It should also be understood by one skilled in the art that the method and devices depicted in FIGS. 1 through 3 may be implemented on a device such as is shown in FIG. 4 and that the devices shown and depicted are non-transitory devices.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods and apparatuses described hereinabove are also contemplated and within the scope of the invention.

I claim:

1. A method comprising:
providing a portable transmitter to each of a plurality of employees present at defined premises;
providing at least one transceiver to at least one marshal present at said premises;
receiving a signal transmitted from an activated transmitter of said plurality of transmitters;
determining a named location within said premises corresponding to said activated transmitter; and
simultaneously sending a notification to said transceiver on said premises and at least one emergency responder based at a location other than said premises, said notification comprising data regarding said activated transmitter.

2. The method of claim 1, wherein said data further comprise said named location of said activated transmitter.

3. The method of claim 2, wherein said data further comprise a proximity of said transceiver to said activated transmitter.

4. The method of claim 2, wherein said data further comprise information regarding a proximity of the transceiver to said activated transmitter compared to proximities of other transceivers.

5. The method of claim 2, wherein said location comprises a room or area identifier.

6. The method of claim 2, wherein said location is determined via a GPS receiver associated with said activated transmitter.

7. The method of claim 2, wherein said location is determined by triangulating said signal.

8. The method of claim 1, wherein said at least one emergency responder is a local police department, emergency medical service or fire department.

9. A method of facilitating emergency response on certain premises, the method comprising:
equipping an armed marshal at said premises with an emergency transceiver;
receiving a signal transmitted from an activated transmitter on said premises;
determining an actual location of said transmitted signal on a pre-configured plan of said premises;
translating said actual location into a named area of said premises;
sending a notification to said transceiver carried by said armed marshal, said notification comprising said named area corresponding to said activated transmitter location; and
communicating said named area and an address of said premises to at least one emergency responder.

10. The method of claim 9, wherein said notification further comprises a distance of said armed marshal to said activated transmitter location.

11. The method of claim 10, wherein said notification further comprises information regarding proximities of other armed marshals with respect to said distance of said armed marshal to said activated transmitter location.

12. The method of claim 9, wherein said notification further comprises displaying said plan to said transceiver.

13. The method of claim 12, wherein said named area of said premises is indicated on said plan.

14. A method of claim 13, wherein a present location of said armed marshal is indicated on said plan.

16. The method of claim 9, further comprising an additional step of:
notifying at least a second marshal about said activated transmitter, and that a closer marshal has also been notified.

17. The method of claim 15, wherein said step of notifying said second marshal further comprises informing said second marshal to proceed accordingly to said location on the basis that said second marshal is the second closest to the activated transmitter.

18. The method of claim 9, wherein said signal from said activated transmitter is received by said transceiver, and a distance to said activated transmitter is determined by assessing the strength of said signal.

19. The method of claim 18, wherein said transceiver uses a direction and said strength of said signal to locate said activated transmitter.

20. A system for responding to an emergency on certain premises, said system comprising:
a plurality of transmitters which transmit signals upon activation, each transmitter associated with an employee present on said premises;
a plurality of transceivers, each transceiver having a display and wireless connectivity, each transceiver associated with an armed marshal present on said premises; and
a server which receives and identifies an origin of said signals and transmits said origin to said transceivers, said server having a processor and memory, said memory comprising pre-configured plan data regarding certain premises.
